(19) United States
(12) Patent Application Publication
(10) Pub. No.: US 2008/0054108 A1
(43) Pub. Date: Mar. 6, 2008

(54) METHOD AND APPARATUS FOR PULPING UNIT

(76) Inventors: Robert J. Matz, Appleton, WI (US); Michael Piper, Appleton, WI (US)

Correspondence Address: TAYLOR & AUST, P.C., P.O. Box 560, 142. S Main Street, Avilla, IN, 46710, US

(21) Appl. No.: 11/468,419

(22) Filed: Aug. 30, 2006

(51) Int. Cl. B02B 1/00

(52) U.S. Cl. 241/46.11

(57) ABSTRACT

A pulper having a tank for receiving materials to be shredded and a drive having a rotating hub within the tank. A rotor is fixed to the rotating output of the drive, the rotor comprising an annular rotatable hub and a plurality of vanes projecting generally axially from the hub. Each of the vanes has a contour that is swept back from the direction of rotation, at least adjacent the radially outermost portion thereof. The vanes have a side edge facing an axial direction and a plurality of teeth are provided on the side edge of the vanes adjacent the radially outermost portion thereof for providing rapid shredding of material with a reduced energy requirement.

### BACKGROUND OF THE INVENTION

1. Field of the Invention

The present invention relates to material reduction and defibering apparatus and methods for the paper and pulp industry.

2. Description of the Related Art

Pulpers are used in the paper and pulp industry to reduce stock material containing fibers into a watery slurry suitable for making paper. The source of fiber may be, e.g. wood fiber in the form of virgin fibers or recycled fiber. Stock material is added to a pulper comprising a tank of water where the stock material is broken down into fibers of a suitable size and consistency to make the desired paper product. The materials to be added into a pulping unit may be provided in baled/wrapped forms, cut rolls or sheeting. Emersion in the tank and the pulper often results in the material staying in a wrapped condition which delays the contact and mixing with water. This extends the total required pulping/slushing time. A manual solution to the problem would be unwrapping of the bale covers and/or loosening of the other layers of materials prior to being added to the pulping unit. However, such additional actions also require manpower and additional time and effort.

Pulpers incorporate rotor vanes in the tank to breakup and reduce the size of the material. Such rotors may be employed in a batch process in which the contents of the tank are pulped until the desired consistency is reached and then the contents of the tanks removed for processing into paper. Another form of pulping may take place on a continuous basis where a majority of the tank contents are recirculated but a portion having the desired consistency is taken off for use in papermaking. Typical rotor vane forms have a swept vane to achieve a pumping action in the tank without requiring excessive amounts of energy. This shape, while minimizing energy requirements, does not lend itself to shredding so that bales and other wrapped material require extended periods before the internal materials become soaked and start to break down.

Thus, a need exists in the art to reduce the shredding time of pulping units having swept rotor vanes.

### SUMMARY OF THE INVENTION

In one form, the invention comprises a rotor for a pulper wherein the rotor comprises an annular rotatable hub. A plurality of vanes project axially from the hub and each of the vanes have a contour that is swept back from the direction of rotation, at least adjacent the radially outermost portion thereof. The vanes have a side edge facing an axial direction. A plurality of teeth are provided on the side edge of the vanes adjacent the radially outermost portion thereof for providing rapid shredding of material.

In another form, the invention comprises a pulper having a tank for receiving materials to be shredded and a drive having a rotating hub within the tank. A rotor is fixed to the rotating output of the drive, the rotor comprising an annular rotatable hub and a plurality of vanes projecting generally axially from the hub. Each of the vanes has a contour that is swept back from the direction of rotation, at least adjacent the radially outermost portion thereof. The vanes have a side edge facing an axial direction and a plurality of teeth on the side edge of the vanes adjacent the radially outermost portion thereof provide rapid shredding of material.

In still another form, the invention comprises a rapid method of shredding material. The method comprises the steps of introducing material and liquid into a tank and displacing a series of teeth through the material and liquid in the tank in a given direction. The teeth are oriented relative to the given direction to produce a wedge-like shearing action on the material and liquid.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 shows, in simplified fashion, a pulper incorporating a rotor, in a first orientation, that embodies the present invention;

FIG. 2 shows, in even more simplified fashion, a pulper incorporating a rotor that embodies the present invention, in another orientation.

FIG. 3 is a perspective view of the rotor used in FIG. 1 and incorporating the present invention; and

FIG. 4 is a fragmentary side view of the rotor of FIG. 3 taken on lines 4-4 of FIG. 3.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

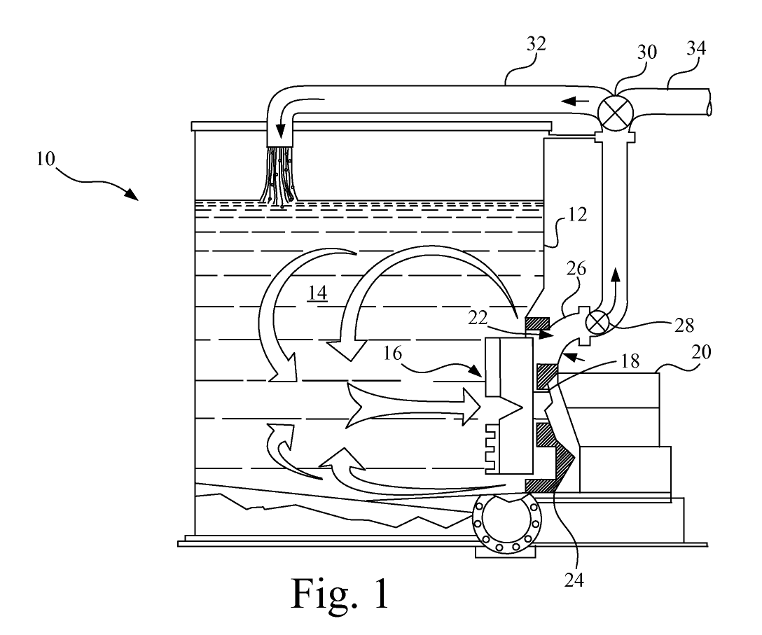

Referring now to the drawings, and more particularly to FIG. 1, there is shown, in simplified fashion, a pulping unit 10 comprising a tank 12 in which a supply of water and materials to be shredded, generally indicated by reference character 14, is introduced into the tank. Tank 12 can assume many different shapes and volumes to accommodate the selected quantity of material to be shredded. Shredding is accomplished by a rotor, generally indicated at 16 which is mounted on a drive shaft 18 connected to an appropriate motor 20 used to drive the rotor 16 in a rotary movement.

As indicated above, the materials 14 in tank 12 may be shredded in batch fashion where the material is introduced into the tank, shredded and then the contents removed when the desired level of shredding is achieved. Alternatively, the pulper 10 could be used on a continuous basis by allowing a clearance 22 of a pre-selected dimension between the periphery of the rotors 16 and a housing 24. The output that is pumped is fed through a conduit 26, past a control valve 28 to a diverter valve 30 that apportions flow between a return conduit 32 and a final product conduit 34. It should be apparent to those skilled in the art that the invention, to be described below, will work with either batch or continuous flow processing.

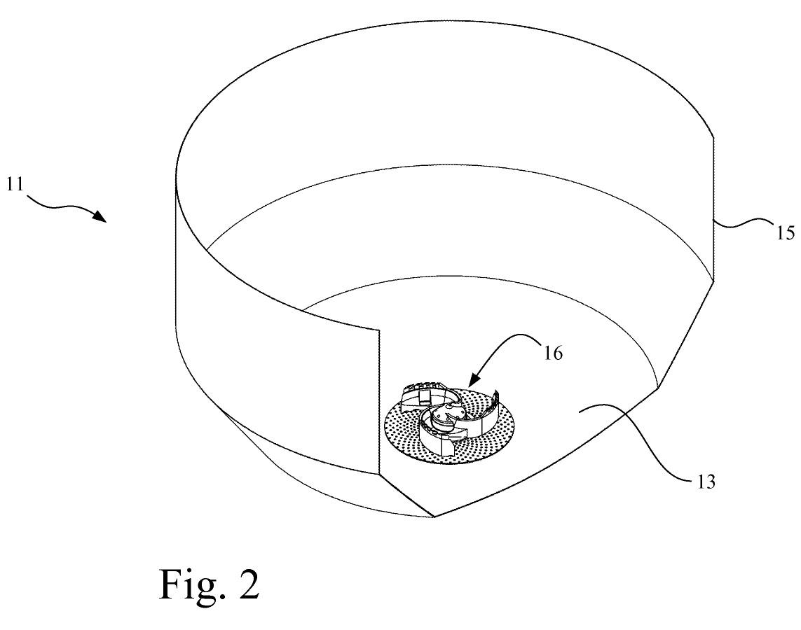

FIG. 1 shows the rotor in an orientation where its rotational axis is horizontal. Many other orientations may be used with the illustrated rotor. For example, FIG. 2 shows a pulper 11 having the rotor 16 oriented so that its axis of rotation is vertical. The rotor 16 is positioned on the bottom wall 13 of a tank 15, that has been cut away to show rotor 16. Rotor 16 is driven by an appropriate drive (not shown) to shred material and water on a batch or continuous basis.

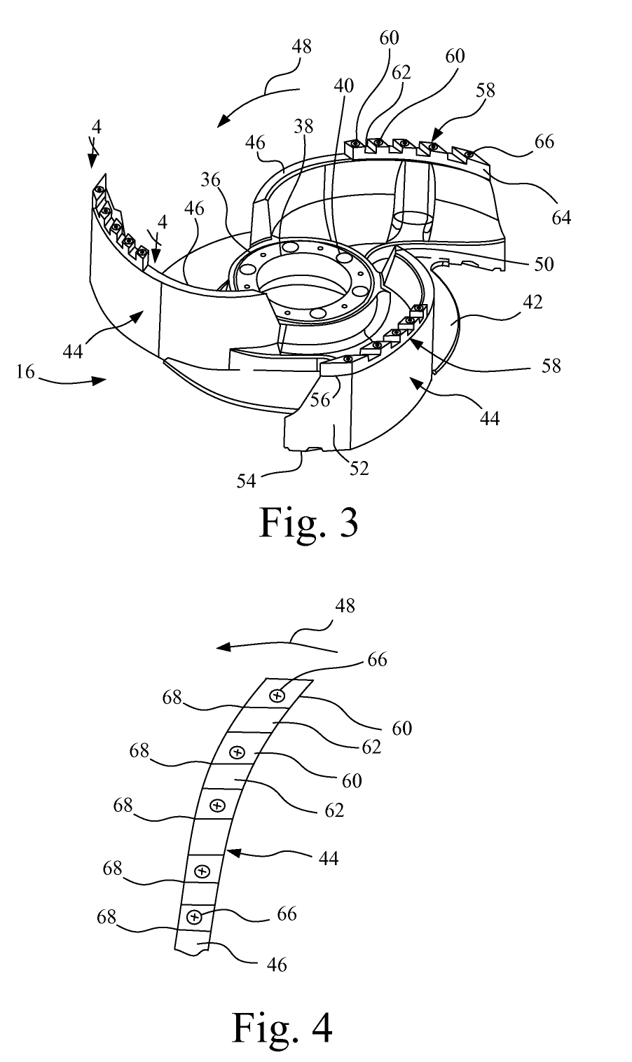

FIG. 3 shows a perspective view of the rotor 16 incorporated in the pulper of FIG. 1 or FIG. 2. Rotor 16 comprises a central annular hub 36 having a central opening 38 received on drive shaft 18. Through holes 40 provide a means to releasably fasten rotor 16 to drive shaft 18 (not shown in FIG. 3). Hub 36 has a radially extending flange 42 and a series of vanes 44 extending from hub 36. Flange 42 structurally reinforces the vanes 44 as well as permitting an opening for recirculation or pumping of material beyond the perimeter of flange 42. Each vane 44 has a width which extends axially from generally the plane of flange 42 to a side edge 46. Although the width of vanes 44 is shown to be of constant dimension, it should be apparent to those skilled in the art that the dimension may vary over the extent of the vane. The vanes 44 are contoured so that they curve (or are swept away) from the direction of rotation indicated by arrow 48. The thickness of vanes 44 varies from the thickness shown at 50 at the radially innermost edge of the vanes 44 to a maximum thickness at 52 at the radially outermost portion of the vanes 44. The difference in thickness is for strength as well as providing an appropriate hydrodynamic flow channel between adjacent vanes for appropriate pumping. As shown in FIG. 3, the base 54 of end 52 adjacent the plane of flange 42 is substantially wider than the top 56 marking the radially outer section of side edge 46. This also is to provide strength to the vanes. It should be apparent to those skilled in the art that thickness variations other than those shown will also be suitable.

In accordance with the present invention, teeth, generally indicated by reference character 58, are provided on the side edges 46 of the vanes adjacent the radially outermost portion 52 of vanes 44. Teeth 58 include a plurality of teeth 60 separated by generally rectangular passages 62. The passages 62 are formed in a base 64 that is, as herein shown, an element separate from the vanes 44. A plurality of screws 66 are provided to releasably connect the base 64 to the side edge 46 of vanes 44. As shown in FIG. 4, the teeth 60 and rectangular passages 62 therebetween present a diamond orientation relative to the direction of flow 48 so that the leading edges 68 of teeth 60 are in a wedge form to facilitate shredding and breaking up of material. As shown particularly in FIG. 4, the passages 62 are generally close to right angles with respect to the side edge 46 of vanes 44. However, because the vanes are swept, the result in presentation, relative to the direction of flow 48, is such that the wedge shape cuts into the material more efficiently. The shredding continues to take place on an ongoing basis by achieving a rapid reduction and particle size. This ultimately speeds up the separation of the fibrous material into the water to form a slurry. Coupled with the swept back vanes 44, the teeth 58 enable a rapid size reduction and greater surface area contact with the water so that pulping times are significantly reduced which in turn results in significant energy savings.

As shown herein, the teeth 58 are separate elements fastened to the vanes 44 using of screws. It should be apparent to those skilled in the art that the teeth 58 may be fastened in other ways, such as welding, or even made integral with the vanes when cast or formed.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A rotor for a pulper, said rotor comprising:
an annular rotatable hub,
a plurality of vanes projecting generally axially from said hub, each of said vanes having a contour that is swept back from a direction of rotation at least adjacent a radially outermost portion thereof, said vanes having a side edge facing an axial direction, and
a plurality of teeth on the side edge of said vanes adjacent the radially outermost portion thereof for providing rapid shredding of material.

2. A rotor as claimed in claim 1, wherein the plurality of teeth are formed in a separate element.

3. A rotor as claimed in claim 2, wherein said separate element is removably fastened to said vanes.

4. A rotor as claimed in claim 2, wherein said separate element is welded to said vanes.

5. A rotor as claimed in claim 1, wherein said vanes have a thickness along said side edge and said teeth are as thick as said vanes.

6. A rotor as claimed in claim 5, wherein the thickness of said vanes increases towards the radially outermost portion thereof.

7. A rotor as claimed in claim 1, wherein said teeth form rectangular passages therebetween.

8. A rotor as claimed in claim 7, wherein the contour of said vane and the orientation of said passages between said teeth results in a diamond configuration for said teeth having a wedge at the leading edge thereof.

9. A pulper comprising:
a tank for receiving materials to be shredded,
a drive having a rotating output in said tank,
a rotor fixed to the rotating output of said drive, said rotor comprising an annular rotatable hub, a plurality of vanes projecting generally axially from said hub, each of said vanes having a contour that is swept back from the direction of rotation at least adjacent a radially outermost portion therof, said vanes having a side edge facing an axial direction, and a plurality of teeth on the side edge of said vanes adjacent the radially outermost portion thereof for providing rapid shredding of material.

10. A pulper as claimed in claim 9, wherein said teeth are formed in a separate element.

11. A pulper as claimed in claim 10, wherein said separate element is removably fastened to said vanes.

12. A pulper as claimed in claim 10, wherein said separate element is welded to said vanes.

13. A pulper as claimed in claim 9, wherein said vanes have a thickness and said teeth are as thick as said vanes.

14. A pulper as claimed in claim 13, wherein the thickness of said vanes increases towards the radially outermost portion thereof.

15. A pulper as claimed in claim 14, wherein the space between said teeth forms substantially rectangular passages in the contour of said vane and the orientation of said passages between said teeth results in a diamond configuration to said teeth having a wedge at the leading edge in the direction of movement.

16. A pulper as claimed in claim 9, wherein said drive and said rotor rotate about a common axis that is horizontally oriented relative to said tank.

17. A pulper as claimed in claim 9, wherein said drive and said rotor rotate about a common axis that is vertically oriented relative to said tank.

18. A method for rapid shredding of material, said method comprising the steps of:
introducing material and liquid into a tank, and
displacing a series of teeth through the material and liquid in the tank in a given direction, said teeth being oriented relative to said given direction to produce a wedge-like shearing action on said material and liquid.

19. A method as claimed in claim 18, wherein said teeth are displaced through rotary motion in said tank.

20. A method as claimed in claim 19, wherein said teeth are adjacent the radially outermost portion of the axis of said rotary motion.

21. A method as claimed in claim 19, wherein said teeth are displaced through said rotary motion by being on a rotating rotor.

22. A method as claimed in claim 21, wherein said teeth are displaced through said rotary motion on an edge of the rotating rotor.
